(19) United States
(12) Patent Application Publication
(10) Pub. No.: US 2026/0230840 A1
(43) Pub. Date: Aug. 6, 2026

(54) Determining a Cellular Footprint of a Radio Access Network (RAN) Antenna

(71) Applicant: TC France S.A.S., Saint-Jacques-de-la-Lande (FR)

(72) Inventors: Juan Jose RUBIO ESTEBAN, Meliana (ES); Maria Amparo NAVARRO PERIS, Alzira (ES); Evarist MARTI CANET, Llutxent (ES); Maria Jose DOMENECH BENLLOCH, Moncada (ES)

(73) Assignee: TC France S.A.S., Saint-Jacques-de-la-Lande (FR)

(21) Appl. No.: 19/462,333

(22) Filed: Jan. 28, 2026

Related U.S. Application Data
(60) Provisional application No. 63/751,899, filed on Jan. 31, 2025.
(60) Provisional application No. 63/802,695, filed on May 9, 2025.

(51) Int. Cl. H04W 16/24; H01Q 1/24

(52) U.S. Cl. CPC H04W 16/24; H01Q 1/246

(57) ABSTRACT

Systems and methods for generating a cellular footprint of a Radio Access Network (RAN) antenna include obtaining antenna transmission power, antenna gain, and cable and connector loss for the RAN antenna; selecting a target power sensitivity value and a set of horizontal directions; for each direction in the set of horizontal directions: initializing a distance value between the antenna and a user device; determining a propagation loss for the distance value; determining a diffraction loss for the distance value; determining an expected received power using a link budget expression; iteratively adjusting the distance value until transmission power converges to the target power sensitivity, thereby determining the maximum distance at which the antenna can achieve the target sensitivity in a direction; and generating the antenna footprint as a function of maximum distance values across all directions.

### CROSS-REFERENCE TO RELATED APPLICATION(S)

The present application claims priority to U.S. Provisional Patent Application No. 63/751,899, filed Jan. 31, 2025, and to U.S. Provisional Patent Application No. 63/802,695, filed May 9, 2025, the contents of each are incorporated by reference in their entirety.

### FIELD OF THE DISCLOSURE

The present disclosure relates generally to wireless networking. More particularly, the present disclosure relates to systems and methods for determining a cellular footprint of a radio access network (RAN) antenna.

### BACKGROUND OF THE DISCLOSURE

In cellular network planning and optimization, accurately determining the geographical coverage, or “footprint,” of an antenna is important. The antenna footprint generally refers to the geographic region in which a user device can receive a signal at or above a defined minimum level (e.g., a receiver sensitivity threshold or minimum acceptable signal strength). Conventional techniques for estimating antenna footprints may include detailed propagation modeling (e.g., ray tracing) or data-driven approaches trained using extensive measurement data. However, such techniques can be computationally intensive, time-consuming to execute, and dependent on high-fidelity environmental models and/or large datasets that may be unavailable, incomplete, or impractical to obtain.

As mobile networks increase in complexity and scale, network operators and planners increasingly benefit from faster and more scalable techniques for estimating coverage over large geographic areas while using limited computational resources. Accordingly, there remains a need for improved approaches that generate accurate antenna footprint estimates using commonly available antenna configuration information and limited environmental data.

### BRIEF SUMMARY OF THE DISCLOSURE

The present disclosure addresses this need by providing techniques that generate antenna coverage footprints using a simplified link budget framework. In various embodiments, the techniques incorporate antenna gain, propagation loss, and diffraction loss, and use an iterative distance estimation process to determine a coverage boundary for multiple azimuth directions. The disclosed techniques enable automated footprint generation with improved computational efficiency while maintaining accuracy suitable for large-scale network planning and optimization.

The present disclosure provides systems and methods for generating a cellular coverage footprint for a RAN antenna. The disclosure includes methods, processing devices configured to perform the methods, and non-transitory computer-readable media storing instructions that, when executed by one or more processors, cause performance of the methods. In various embodiments, a method includes obtaining antenna transmission power (Ptx), antenna gain (G(φ,θ)), and cable/connector loss (Lcable) for the RAN antenna; selecting a target receiver sensitivity value and a set of horizontal directions (φ); and, for each direction, determining a maximum distance at which a user device is expected to receive a signal at or above the target receiver sensitivity. Determining the maximum distance can include initializing a distance value between the antenna and the user device; calculating propagation loss (Lprop) for the distance value using a propagation model; calculating diffraction loss (Ldiff) for the distance value using terrain elevation data along a line of sight between the antenna and the user device; calculating an expected received power (Prx) using a link budget expression incorporating Ptx, G(φ,θ), Lcable, Lprop, and Ldiff; iteratively adjusting the distance value until the expected received power (Prx) converges to the target receiver sensitivity; and generating the antenna footprint based on the maximum distance values across the set of directions q.

In some embodiments, the antenna gain (G(φ,θ)) is determined from horizontal and vertical radiation patterns of the antenna and can account for antenna tilt, beamwidth, and front-to-back ratio. The propagation loss (Lprop) can be computed using a line-of-sight propagation model selected based on a deployment environment, including Rural Macro (RMa), Urban Macro (UMa), and Urban Micro (UMi) scenarios. The diffraction loss (Ldiff) can be computed based on one or more terrain obstructions intersecting the line of sight between the antenna and the user device. In some embodiments, the method includes post-processing to enforce monotonicity across multiple receiver sensitivity values such that, for a given direction, a footprint corresponding to a higher sensitivity threshold does not extend beyond a footprint corresponding to a lower sensitivity threshold. In some embodiments, distance values for directions in which convergence is not achieved are interpolated using distance values from adjacent directions. In some embodiments, the distance value is initialized using an estimated distance determined without accounting for diffraction loss (Ldiff). In some embodiments, the method is repeated for multiple target receiver sensitivity values to generate multiple footprint contours corresponding to different receiver sensitivity thresholds. Terrain elevation data can be obtained from a topographical database, including Shuttle Radar Topography Mission (SRTM) data. In some embodiments, at least a portion of the steps are executed in parallel to generate footprints for multiple antennas and/or multiple sensitivity levels concurrently.

### BRIEF DESCRIPTION OF THE DRAWINGS

The present disclosure is detailed through various drawings, where like components or steps are indicated by identical reference numbers for clarity and consistency.

FIG. 1 is a diagram of an example antenna radiation pattern in both planes.

FIG. 2 is a diagram visualizing propagation loss.

FIG. 3 is a diagram representing a signal line obstructed by an obstacle.

FIG. 4 is a flowchart of a process for determining an antenna's cellular footprint.

### DETAILED DESCRIPTION OF THE DISCLOSURE

Cellular network antennas are core components of wireless communication systems and serve as a physical interface between user devices and a mobile network. Such antennas are commonly deployed as part of a RAN and may be mounted on towers, rooftops, or utility poles. In operation, an antenna transmits and receives RF signals to provide wireless connectivity within a defined geographic region, which may be referred to as a cell or sector. Antennas convert electrical signals into electromagnetic waves for transmission, and convert received electromagnetic waves back into electrical signals for processing. Many cellular antennas are directional and are configured to concentrate radiated energy in selected directions based on parameters such as antenna gain, azimuth orientation, tilt, beamwidth, front-to-back ratio, and transmission power. Directional operation can improve coverage and capacity while reducing interference.

The effective operating range of a cellular antenna depends on multiple factors, including propagation environment, carrier frequency, antenna height, transmit power, and antenna gain. For example, in relatively open rural environments with fewer obstructions, RF signals may propagate over several kilometers, while in dense urban environments, buildings and other structures may significantly limit propagation distance. Lower frequency bands (e.g., about 700 MHz) often provide longer range and improved penetration through structures compared to higher frequency bands (e.g., about 3.5 GHz or millimeter-wave frequencies). In addition, antennas deployed at greater heights can provide expanded coverage in some scenarios due to reduced obstructions along a propagation path.

Accurately determining the coverage area, or footprint, of a cellular antenna is important for mobile network operators and planners. Footprint estimation enables improved network design, including identifying potential coverage gaps, planning handovers between adjacent cells, and supporting frequency reuse and interference management. Footprint information can also support network optimization, regulatory compliance, and reduced infrastructure deployment costs. Conventional footprint estimation techniques, such as drive testing, ray-tracing simulations, or data-intensive machine learning approaches, may be costly, labor-intensive, and/or computationally demanding. Accordingly, there remains a need for improved computational techniques that generate accurate antenna coverage predictions using readily available antenna configuration information and limited environmental data.

The present disclosure relates to methods for calculating cellular coverage footprints in a manner that avoids highly complex and/or resource-intensive techniques. In particular, the disclosed methods do not require generating highly detailed propagation models such as ray-tracing simulations, which can be computationally intensive and time-consuming. The disclosed methods also do not require training artificial intelligence (AI) models using large-scale datasets of user equipment (UE) measurements for each individual cell. Instead, the present disclosure provides a practical and computationally efficient approach for footprint estimation while maintaining accuracy sufficient for network planning and optimization.

The present disclosure introduces techniques for computing cell footprints based on antenna configuration information together with basic environmental information. In various embodiments, the antenna configuration information includes one or more of antenna geographic position, azimuth orientation, transmission power, antenna gain, signal losses (e.g., feeder/cable loss), mechanical and/or electrical tilt, installation height, horizontal and vertical beamwidth, front-to-back ratio, and operating frequency. The environmental information can include inter-site distance (ISD) between neighboring cells and terrain elevation data. The terrain elevation data can be obtained from publicly available sources such as Shuttle Radar Topography Mission (SRTM) datasets. By integrating these inputs, the disclosed techniques enable accurate and efficient estimation of cell coverage areas without requiring high-complexity simulations or extensive measurement campaigns.

In some embodiments, the techniques include, for a given antenna, determining a maximum distance at which a specified receiver sensitivity level is achieved for each of a plurality of directions around the antenna. In one example, in Long Term Evolution (LTE) networks, the receiver sensitivity may be characterized in terms of Reference Signal Received Power (RSRP), which may range from approximately −44 dBm (very strong) to approximately −156 dBm (lower detectability threshold). By evaluating one or more such sensitivity thresholds, the disclosed techniques determine radial distances at which corresponding received power levels are expected to be achieved, while accounting for direction-dependent antenna gain based on the antenna radiation pattern. Repeating the distance estimation across multiple directions enables generation of a coverage contour representative of the antenna footprint, thereby supporting improved network planning and optimization.

In accordance with one embodiment, the present disclosure provides a method for calculating a coverage footprint of RAN antenna using an iterative distance estimation process. The method includes obtaining antenna-specific parameters, such as antenna transmission power (Ptx), direction-dependent antenna gain (G(φ,θ)), and cable and connector losses (Lcable). These parameters are used to model expected signal levels at locations surrounding the antenna.

For a selected target power sensitivity value corresponding to a minimum received signal level for reliable reception, the method evaluates a coverage boundary in a plurality of horizontal directions. For each direction φ in a defined set of azimuth angles, the method initializes a distance value between the antenna and a user device. In some embodiments, the initial distance value is estimated using a simplified computation that excludes one or more loss components (e.g., diffraction loss) and identifies a distance at which an expected received power is approximately equal to the target power sensitivity.

For a given distance value, the method determines propagation loss (Lprop) based on a propagation model, and determines diffraction loss (Ldiff) based on terrain elevation data along a line of sight between the antenna and the user device. The method then computes an expected received power (Prx) using a link budget expression that incorporates Ptx, G(φ,θ), Lcable, Lprop, and Ldiff.

The distance value is iteratively adjusted until the expected received power (Prx) converges to the target power sensitivity value. The converged distance value is then recorded as a maximum distance at which the antenna is expected to satisfy the target power sensitivity in the corresponding direction q. Repeating the iterative distance estimation across the set of horizontal directions enables generation of a directionally dependent coverage footprint for the RAN antenna.

In some embodiments, the method is repeated for a plurality of target power sensitivity levels to generate multiple footprint contours corresponding to different signal quality thresholds and/or service availability levels.

The method is adaptable to a variety of deployment scenarios. For example, the method can accommodate cells that include multiple antennas deployed at different physical locations. The method can further account for variability in antenna configuration data provided by different vendors and network operators, including differences in parameter formats, units, and reporting conventions. In some embodiments, the method is configured to generate a footprint estimate even when one or more input parameters are unavailable, incomplete, or inferred.

In some embodiments, the method is configured to provide a usable footprint estimate when an iterative solution does not converge for one or more directions and/or sensitivity levels. In addition, the method can be implemented for large-scale network planning by using parallel processing, such that footprint estimates for multiple antennas and/or multiple sensitivity levels are generated concurrently across multiple processing threads.

In some embodiments, a footprint generator estimates a coverage area of a cellular antenna using a link budget-based approach that models a received power at a user device by accounting for signal gains and losses between the antenna and the user device. In one example, an expected received power (Prx) is expressed as:

Prx=Ptx+G(φ,θ)−Lcable−Lprop(dtx-rx)−Ldiff(terrain,dtx-rx,φ,θ),
where Prx is the expected received power at the user device; Ptx is the antenna transmission power; G(φ,θ) is an antenna gain as a function of azimuth (φ) and elevation (θ), including antenna tilt and antenna radiation patterns in horizontal and vertical planes; Lcable represents cable and connector losses; Lprop represents propagation loss as a function of distance between the antenna and the user device (dtx-rx); and Ldiff represents diffraction loss based on terrain elevation data and a geometric relationship between the antenna and the user device. In various embodiments, the method determines, for each horizontal direction q, a maximum distance (dtx-rx) at which the expected received power satisfies a selected receiver sensitivity threshold, thereby enabling generation of a directionally dependent coverage footprint.

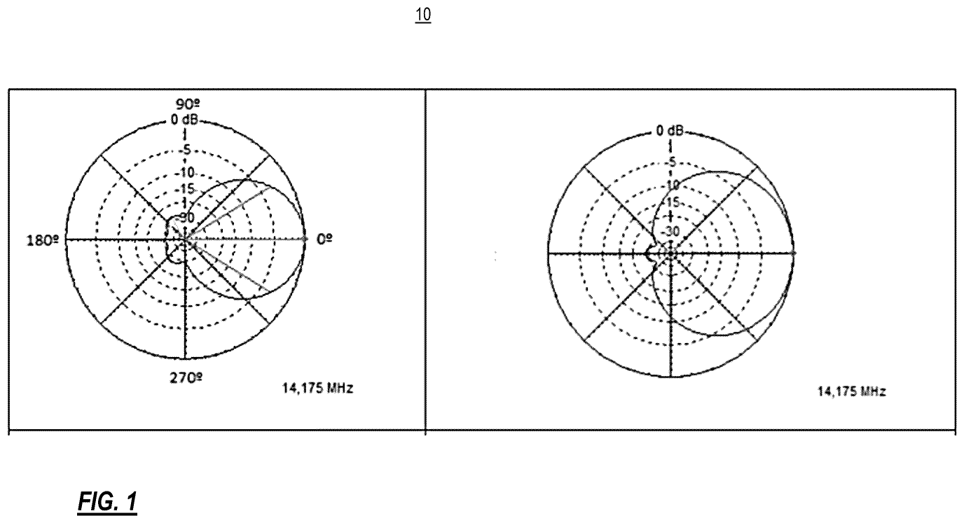

To accomplish this, the method integrates multiple sub-methods corresponding to respective terms of a link budget. A first sub-method determines a direction-dependent antenna gain G(φ,θ), which represents the antenna's ability to radiate and/or receive energy in a given azimuth direction and elevation direction θ relative to an isotropic reference. In various embodiments, G(φ,θ) is derived from one or more antenna radiation pattern diagrams 10 shown in FIG. 1, which may be provided by an antenna vendor, derived from standardized pattern models, and/or obtained from measurement data. The radiation pattern diagrams 10 can include a horizontal (azimuth-plane) pattern and a vertical (elevation-plane) pattern, each expressed in polar coordinates as relative gain (e.g., in dB) versus angle. The method can apply the diagrams 10 to compute a composite gain value for a selected direction by (i) selecting a gain value from the horizontal pattern for a given azimuth φ, (ii) selecting a gain value from the vertical pattern for a corresponding elevation θ, and (iii) optionally combining the selected values (e.g., by summation in dB with an offset corresponding to a peak gain). In some embodiments, the gain computation further accounts for antenna configuration parameters such as mechanical and/or electrical downtilt, beamwidth, and front-to-back ratio by shifting, rotating, or otherwise mapping the pattern data to the antenna's installed orientation. Accordingly, the method models realistic gain roll-off as an angular deviation increases from a main lobe boresight direction, which improves the accuracy of received-power prediction for different bearings around the antenna.

FIG. 1 is an example set of antenna radiation pattern diagrams 10 for an antenna at an example operating frequency (e.g., 14.175 MHz). In the illustrated embodiment, FIG. 1 includes two polar plots representing relative gain as a function of angle. A first polar plot 12 (upper plot) depicts a first-plane radiation pattern (e.g., an elevation-plane or E-plane pattern) in which gain varies with elevation angle θ relative to a boresight direction. A second polar plot 14 (lower plot) depicts a second-plane radiation pattern (e.g., an azimuth-plane or H-plane pattern) in which gain varies with azimuth angle φ around the antenna. Concentric rings of the polar plots represent relative gain levels (e.g., 0 dB, −5 dB, −10 dB, −15 dB, −20 dB, −30 dB), and radial lines indicate angular references (e.g., 0°, 90°, 180°, and 270°). Each plot includes a main lobe region corresponding to a direction of maximum radiation and one or more side lobe and/or back lobe regions representing reduced radiation away from boresight. In some embodiments, the method uses the diagrams 10 to obtain gain values for selected (φ′θ) directions, apply downtilt or other orientation adjustments, and thereby compute a direction-dependent antenna gain term G(φ,θ) for use in the link budget.

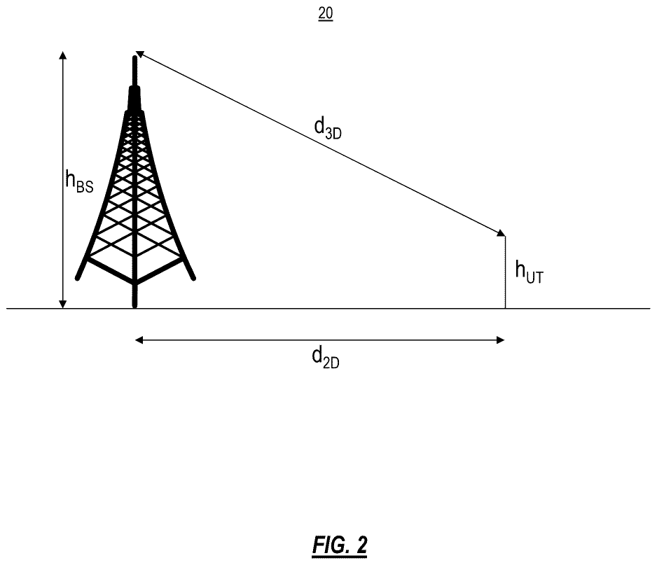

Another parameter in an RF link budget is propagation loss (also referred to as path loss), which represents a reduction in signal power as an RF signal propagates from a transmitting antenna toward a receiving device. FIG. 2 is a diagram 20 illustrating propagation loss as a function of separation distance between a transmitter and a receiver. In general, propagation loss increases with distance and depends on deployment conditions (e.g., carrier frequency, antenna heights, and an environmental scenario). Accurate modeling of propagation loss improves prediction of coverage boundaries and received power levels used for network planning and optimization.

In various embodiments, the method uses line-of-sight (LoS) propagation expressions defined in the 3GPP TR 38.901 technical report, which provides standardized path loss formulations for multiple radio environments. Although the 3GPP expressions may be used as a baseline, the disclosed framework is not limited thereto, and can alternatively employ other path loss models (including operator- or vendor-specific models) based on target accuracy, computational constraints, and deployment characteristics.

In some embodiments, the method applies LoS propagation expressions and separately models additional attenuation attributable to obstructions via a diffraction loss component. This separation can reduce or avoid double-counting losses by treating distance-based propagation behavior using the propagation model and treating terrain-induced obstruction effects using the diffraction model.

In some embodiments, the method is configured for outdoor macro-coverage planning and excludes indoor antenna footprints. For outdoor operation, the method classifies a coverage computation into one of a plurality of deployment scenarios, such as:
Rural Macro (RMa), representative of rural areas with relatively large inter-site distances (ISD) and comparatively low building density;
Urban Macro (UMa), representative of suburban or lower-density urban environments with moderate ISD; and
Urban Micro (UMi), representative of denser urban deployments with comparatively shorter ISD and more complex propagation conditions.

The method is configured to compute propagation loss (e.g., in dB) for a candidate transmitter-receiver separation distance, and, in some embodiments, to estimate a distance corresponding to a selected propagation loss value. For certain scenarios and/or model formulations, a closed-form inversion of the propagation expression may be unavailable or undesirable. In such cases, the method can determine a distance using an iterative process (e.g., evaluating propagation loss at successive distances until a target loss value is satisfied), thereby supporting consistent footprint computations across multiple scenarios.

In addition to propagation loss, the method determines a diffraction loss component (e.g., L^{diff}) that estimates additional attenuation caused by terrain-induced obstructions along a line of sight between the transmitting antenna and the receiving device. Terrain elevation data used for diffraction loss determination can be obtained from a topographical database, such as Shuttle Radar Topography Mission (SRTM) data.

In some embodiments, diffraction loss determination includes identifying one or more topographic features (e.g., hills, ridgelines, or elevated terrain) that intersect or approach the geometric line of sight between the antenna and the user device, and quantifying an associated attenuation based on obstruction geometry. Incorporating diffraction loss can improve footprint accuracy in environments where terrain variations materially affect RF propagation.

FIG. 2 is a diagram 20 illustrating propagation loss (path loss) behavior between a transmitting antenna and a receiving user device as a function of transmitter-receiver separation distance d. In the illustrated embodiment, the diagram 20 conceptually shows that propagation loss increases with distance and can vary based on an environmental scenario and modeling assumptions. In some embodiments, the propagation loss represented in FIG. 2 corresponds to a line-of-sight (LoS) path loss expression (e.g., as defined by 3GPP TR 38.901) selected according to a deployment scenario such as Rural Macro (RMa), Urban Macro (UMa), or Urban Micro (UMi). FIG. 2 further illustrates that, for a given distance d, a propagation loss value Lₚᵣₒₚ (d) can be determined and used as an input to a link budget calculation, and that, conversely, a distance can be estimated for which a target propagation loss value is achieved (e.g., using an iterative inversion). In some embodiments, additional obstruction-related attenuation is not included in Lₚᵣₒₚ and is instead captured separately by a diffraction loss term based on terrain elevation data.

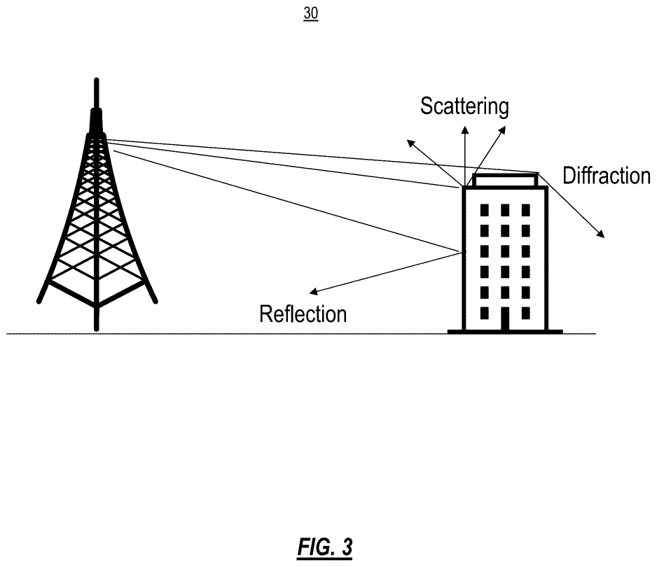

To perform the diffraction loss calculation, the method determines whether one or more terrain features obstruct a line of sight (LoS) path between a transmitting antenna and a receiving user device. In various embodiments, the method models the LoS path as a straight line segment between (i) an antenna height above a ground elevation at a transmitter location and (ii) a receiver height above a ground elevation at a receiver location. The method then evaluates a terrain elevation profile along the LoS path at a plurality of sampled points between the transmitter and the receiver. For each sampled point, the method compares (a) a terrain elevation value at that point to (b) a corresponding LoS height value at the same horizontal position. If the terrain elevation exceeds the LoS height at a sampled point, the method identifies that point as an obstruction (also referred to as a “cut”) in the LoS path, as conceptually illustrated in FIG. 3.

After identifying obstructions, the method selects a diffraction loss model based on a number of cuts and/or a geometry of the obstructions. In some embodiments, when a single dominant obstruction is detected, the method applies a single knife-edge diffraction model to estimate attenuation attributable to that obstruction. When two obstructions are detected, the method applies a double knife-edge diffraction model to estimate attenuation attributable to the two obstructions. When three or more obstructions are detected, the method applies a multi-obstacle diffraction model, such as a Bullington-based model that approximates multiple obstructions using an equivalent single obstruction. In some embodiments, one or more of the knife-edge and Bullington models are implemented in accordance with ITU-R P.526 (e.g., ITU-R P.526-15).

This adaptive model selection can improve accuracy across a range of terrain conditions while maintaining computational efficiency. For example, selecting a single-obstacle model for a single dominant ridge can reduce computation relative to multi-obstacle processing, while selecting a multi-obstacle model for complex terrain can reduce underestimation of diffraction losses.

In various embodiments, the diffraction loss determined using FIG. 3 is combined with antenna gain and propagation loss to estimate received power at candidate receiver locations. The resulting link budget can be used to determine a maximum distance in a given direction at which a selected receiver sensitivity threshold is satisfied, thereby contributing to generation of an antenna footprint.

In some embodiments, the method accounts for the fact that both propagation loss and diffraction loss depend on transmitter-receiver separation distance. Accordingly, the method determines propagation loss and diffraction loss in an iterative process in which a candidate distance is selected, corresponding loss terms are computed for that distance, and the candidate distance is adjusted until a received power value converges to a target sensitivity value. This iterative coupling can produce a consistent solution in which both distance-dependent losses are jointly satisfied.

FIG. 3 is a diagram 30 illustrating determination of terrain-induced obstructions along a LOS path between a transmitting antenna and a receiving user device. In the illustrated embodiment, a terrain elevation profile is shown along a horizontal distance axis between the transmitter and the receiver. A straight-line LoS path extends between the antenna height at the transmitter location and the receiver height at the receiver location. One or more intersections between the terrain elevation profile and the LoS path represent obstructions (cuts) where terrain elevation exceeds the LoS height. In various embodiments, the method identifies the number and geometry of the obstructions and selects a corresponding diffraction loss model (e.g., single knife-edge, double knife-edge, or multi-obstacle/Bullington) to compute a diffraction loss term used in a link budget.

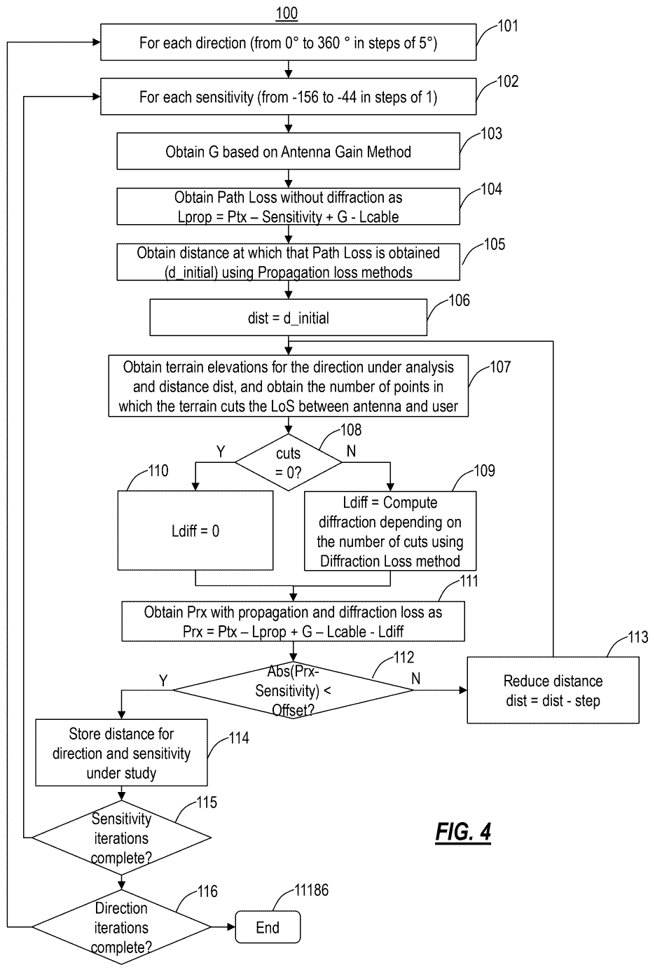

FIG. 4 is a flow diagram illustrating an example footprint-generation method 100 for estimating a coverage boundary of a RAN antenna as a function of horizontal direction and one or more receiver sensitivity thresholds. In step 101, the method 100 selects a horizontal direction φ for evaluation (for example, sweeping azimuth from about 0° to about 360° in fixed increments, such as) 5°. In step 102, the method 100 selects a target sensitivity value (for example, sweeping receiver sensitivity from about −156 dBm to about −44 dBm in fixed increments, such as 1 dB). The method 100 then determines a direction-dependent gain to be used for that ø (and an associated elevation angle θ, if applicable).

In step 103, the method 100 obtains an antenna gain value G(φ,θ) using an antenna gain method (for example, using horizontal and/or vertical radiation pattern data, optionally adjusted for azimuth orientation, tilt, beamwidth, and/or other antenna configuration parameters). In step 104, the method 100 determines a target propagation loss value assuming no diffraction loss, thereby producing a best-case (or baseline) path loss to be “explained” by distance-dependent propagation alone. In the illustrated embodiment, the diffraction-free target propagation loss is computed as:

$${L}_{prop , target} = {P}_{tx} - Sensitivity + G ( ϕ , θ ) - {L}_{c a b l e} ,$$

where Pₜₓ is antenna transmission power, Sensitivity is the selected receiver sensitivity threshold, G(φ,θ) is antenna gain, and L_{cable} represents cable and connector losses.

In step 105, the method 100 estimates an initial transmitter-receiver separation distance dᵢₙᵢₜᵢₐₗ corresponding to the diffraction-free target propagation loss value L_{prop,target}, using one or more propagation loss models (for example, an outdoor line-of-sight (LoS) model selected based on an environment classification such as RMa, UMa, or UMi). In step 106, the method 100 initializes a candidate distance variable dist to the initial estimate, for example dist=dᵢₙᵢₜᵢₐₗ. In some embodiments, step 105 includes an iterative inversion when the selected propagation model does not provide a closed-form solution for distance.

In step 107, the method obtains terrain elevation samples along the direction pout to the candidate distance dist and determines a number of terrain “cuts” in which sampled terrain elevations intersect or exceed a geometric LoS line between the antenna and a hypothetical user device at distance dist. In step 108, the method 100 evaluates whether the number of cuts is zero. If no cuts are detected, then in step 109 the diffraction loss is set to zero (for example L_{diff}=0). If one or more cuts are detected, then in step 110 the method 100 computes a diffraction loss L_{diff} based on the number of cuts and associated obstruction geometry using a diffraction loss method (for example, single knife-edge for one cut, double knife-edge for two cuts, and a multi-obstacle approximation such as Bullington for three or more cuts).

In step 111, the method 100 computes an expected received power Prx for the candidate distance dist using a link-budget expression including propagation and diffraction loss terms. In the illustrated embodiment, the received power is computed as:

$${P}_{r x} = {P}_{tx} - {L}_{prop} ( d i s t ) + G ( ϕ , θ ) - {L}_{cable} - {L}_{diff} ,$$

where Lₚᵣₒₚ (dist) is a propagation loss value computed for the candidate distance dist using the selected propagation model.

In step 112, the method 100 compares the computed expected received power Pᵣₓ to the selected sensitivity threshold to determine whether a convergence criterion is satisfied. In the illustrated embodiment, convergence is satisfied when:

$$\vert {P}_{r x} - Sensitivity \vert < Offset$$

where Offset is a tolerance value (for example, a configurable threshold in dB that defines acceptable error around the target sensitivity). If convergence is satisfied, then in step 113 the method 100 stores the candidate distance dist as a maximum distance for the current direction pand sensitivity threshold.

If convergence is not satisfied in step 112, then in step 114 the method 100 updates the candidate distance dist and repeats one or more of steps 107 through 112. In the illustrated embodiment, because the initial distance estimate dᵢₙᵢₜᵢₐₗ is generated without diffraction, the initial estimate can overstate range in directions where terrain introduces additional loss. Accordingly, step 114 reduces the candidate distance, for example dist=dist−step, where step is a configurable distance decrement. The method 100 then returns to step 107 to recompute cuts, diffraction loss, and received power at the updated distance.

After storing the distance value for the current sensitivity in step 113, the method 100 proceeds to step 115 to determine whether sensitivity iterations are complete for the current direction φ. If not complete, the method 100 returns to step 102 to select the next sensitivity threshold and repeats steps 103 through 113 (and steps 114, as needed). If complete, the method 100 proceeds to step 116 to determine whether direction iterations are complete. If not complete, the method 100 returns to step 101 to select the next direction pand repeats the sensitivity sweep for that direction.

When direction iterations are complete in step 116, the method 100 ends in step 117. The stored maximum distance values across directions ¢ (and, optionally, across multiple sensitivity thresholds) collectively define one or more footprint contours representing estimated coverage boundaries for the antenna.

In some embodiments, the method 100 further includes optional post-processing (not shown) applied to the stored distances to improve contour consistency and visual smoothness. For example, for a given direction φ, the method can enforce a monotonic relationship across sensitivity thresholds such that a contour corresponding to a more stringent sensitivity (higher required received power) does not extend farther than a contour corresponding to a less stringent sensitivity. As another example, if the iterative loop fails to converge for a particular direction at one or more sensitivity thresholds, the method 100 can interpolate a replacement distance using distances stored for adjacent directions to reduce discontinuities in the resulting footprint.

FIG. 4 is a flow diagram of an example method 100 for generating an antenna footprint by iterating over horizontal directions φ (step 101) and receiver sensitivity thresholds (step 102), obtaining a direction-dependent antenna gain G (φ,θ) (step 103), computing an initial distance estimate based on a diffraction-free propagation loss target (steps 104-106), evaluating terrain cuts and computing diffraction loss L_{diff} (steps 107-110), computing received power Pᵣₓ using a link budget (step 111), iteratively adjusting distance until a convergence criterion relative to the selected sensitivity is satisfied (steps 112 and 114), storing the converged distance for the current direction and sensitivity (step 113), and repeating the process until sensitivity and direction iterations are complete (steps 115-117), thereby producing one or more footprint contours.

### SUMMARY

The systems and methods described herein provide improved techniques for determining a cellular footprint of a RAN antenna in a manner that is computationally efficient, scalable, and practical for real-world deployments. In particular, the disclosed approach uses a simplified link budget framework that combines (i) direction-dependent antenna gain derived from antenna pattern data (e.g., FIG. 1), (ii) standardized propagation loss expressions (e.g., LoS models such as those in 3GPP TR 38.901), and (iii) terrain-based diffraction loss derived from elevation data (e.g., FIG. 3). By separating propagation loss and terrain obstruction effects into distinct components, and by iteratively solving for a distance that satisfies a selected receiver sensitivity threshold, the method avoids the computational and data burdens associated with ray-tracing simulations and large-scale measurement-driven or machine-learning approaches, while still accounting for directionality and terrain variability.

The disclosed method further provides technical advantages over conventional footprint generation by (a) producing a directionally resolved coverage boundary across a full set of azimuth directions (step 101) and across multiple receiver sensitivity thresholds (step 102), (b) using a diffraction-free initial distance estimate (steps 104-106) to accelerate convergence, and (c) adaptively computing diffraction loss based on a number of detected terrain cuts (steps 107-110), thereby applying an appropriate diffraction model for the complexity of the intervening terrain. The iterative loop of computing received power (step 111), evaluating a convergence criterion (step 112), and adjusting distance (step 114) provides a consistent solution in which distance-dependent propagation loss and distance-dependent diffraction loss are jointly satisfied, which improves accuracy relative to approaches that treat these losses independently or that risk double-counting obstruction effects. In addition, the method supports robust execution in operational settings by enabling parallel processing across antennas and/or thresholds, accommodating heterogeneous vendor parameter formats, and optionally applying post-processing to enforce monotonic contour behavior across sensitivity levels and to interpolate values where convergence is not achieved.

Accordingly, the disclosed systems and methods provide a novel and advantageous mechanism for automated generation of antenna footprint contours using readily available antenna configuration information and limited environmental data (e.g., publicly available terrain elevation datasets). These techniques enable faster network-wide coverage estimation and support planning, optimization, and performance prediction across large-scale RAN deployments, while reducing required compute resources and limiting dependence on costly drive-testing campaigns or high-fidelity environmental models.

### Processing Circuitry and Non-Transitory Computer-Readable Mediums

Embodiments of the present disclosure may be implemented using various forms of processing circuitry. Non-limiting examples of processing circuitry include general-purpose microprocessors, central processing units (CPUs), digital signal processors (DSPs), specialized processors such as network processors (NPs) or network processing units (NPUs), graphics processing units (GPUs), tensor processing units (TPUs), field-programmable gate arrays (FPGAs), programmable logic devices (PLDs), application-specific integrated circuits (ASICs), and combinations thereof. The processing circuitry may execute program instructions (software and/or firmware) stored in one or more memories to perform, alone or in combination with other circuits, some or all of the operations described herein. In other embodiments, some or all such operations may be implemented in hardware (e.g., using dedicated logic, configurable logic, and/or state machines), including implementations that do not rely on stored program instructions. Hybrid implementations combining software-driven processors, configurable logic, and dedicated hardware are also contemplated. As used herein, “circuitry,” “logic,” or “circuits” that are “configured to” or “adapted to” perform an operation may include hardware alone, or hardware in combination with software and/or firmware.

Further embodiments may include one or more non-transitory computer-readable storage media storing computer-executable instructions that, when executed by a computer, server, appliance, device, module, processor, or other system incorporating processing circuitry, cause the system to perform the operations described and claimed herein. Non-transitory computer-readable storage media include, by way of example, magnetic storage devices, optical storage devices, hard disks, solid-state drives, read-only memory (ROM), programmable read-only memory (PROM), erasable programmable read-only memory (EPROM), electrically erasable programmable read-only memory (EEPROM), flash memory, and any suitable combination thereof. The instructions stored on such media, when executed by one or more processors and/or programmable circuitry, direct the system to perform the operations, steps, methods, processes, algorithms, functions, and techniques of the disclosed embodiments.

### CONCLUSION

In this disclosure, including the claims, the phrases “at least one of” and “one or more of,” when used with a list of items, encompass any individual item and any combination of the listed items. For example, “at least one of A, B, or C” and “one or more of A, B, or C” include A alone, B alone, C alone, any combination of two of A, B, and C, or all three of A, B, and C. The terms “comprise,” “comprises,” “comprising,” “include,” “includes,” and “including” are used in an open-ended, non-limiting sense, such that recited elements or steps are included without excluding additional elements or steps.

The drawings, descriptions, and examples are provided for illustration and explanation and are not intended to be limiting. Modifications, substitutions, additions, omissions, and rearrangements may be made without departing from the spirit and scope of the disclosure. Unless expressly stated otherwise, steps depicted or described in a particular order need not be performed in that order, and no such ordering implies that each step is required. Steps may be performed before, after, concurrently with, or interleaved among other steps, and parallel execution and other concurrent techniques are contemplated. Likewise, the allocation of functions or components among modules, devices, or system elements is exemplary; functions may be combined, subdivided, centralized, or distributed in any suitable manner.

The scope of the disclosure is defined by the claims and includes all equivalents and variations that implement the disclosed principles. References to specific embodiments and examples are provided to explain the disclosure, and are not intended to exclude other implementations. Accordingly, the disclosure encompasses alternative configurations and implementations, including combinations and sub-combinations of the described elements, operations, methods, processes, algorithms, functions, techniques, modules, and circuits, whether implemented collectively, separately, or in any subset.

What is claimed is:

1. A method for generating a cellular footprint of a Radio Access Network (RAN) antenna, the method comprising steps of:
obtaining antenna transmission power (Ptx), antenna gain (G(φ,θ)), and cable and connector loss (Lcable) for the RAN antenna;
selecting a target power sensitivity value and a set of horizontal directions (φ);
for each direction φ in the set of horizontal directions:
initializing a distance value between the antenna and a user device;
determining a propagation loss (Lprop) for the distance value based on a propagation model;
determining a diffraction loss (Ldiff) for the distance value based on terrain elevation data along a line of sight between the antenna and the user device;
determining an expected received power (Prx) using a link budget expression incorporating Ptx, G(φ,θ), Lcable, Lprop, and Ldiff;
iteratively adjusting the distance value until Prx converges to the target power sensitivity, thereby determining a maximum distance at which the antenna can achieve the target sensitivity in direction φ; and
generating the antenna footprint as a function of maximum distance values across all directions φ.

2. The method of claim 1, wherein the antenna gain (G(φ,θ)) is calculated based on horizontal and vertical radiation pattern diagrams of the antenna, including consideration of antenna tilt, beamwidth, and front-back ratio.

3. The method of claim 1, wherein the propagation loss (Lprop) is calculated using a line-of-sight model, the model being chosen based on a deployment environment including any of Rural Macro (RMa), Urban Macro (UMa), and Urban Micro (UMi) scenarios.

4. The method of claim 1, wherein the diffraction loss (Ldiff) is calculated based on a number of topographic obstructions intersecting the line of sight.

5. The method of claim 1, further comprising post-processing data such that a maximum distance at which a higher sensitivity is achieved is not less than a distance for a lower sensitivity in a same direction.

6. The method of claim 1, further comprising interpolating distance values for directions in which the method fails to converge, based on corresponding distance values from adjacent directions.

7. The method of claim 1, wherein the distance value is calculated by estimating a distance at which the target sensitivity is met without accounting for diffraction loss (Ldiff).

8. The method of claim 1, wherein the method is repeated for a plurality of target power sensitivity values, resulting in a plurality of footprint contours corresponding to different receiver sensitivity thresholds.

9. The method of claim 1, wherein terrain elevation data is derived from a topographical database, including Shuttle Radar Topography Mission (SRTM) data.

10. The method of claim 1, wherein the steps are executed in parallel threads to generate footprints for multiple antennas or sensitivity levels simultaneously.

11. The method of claim 1, wherein the initializing distance is computed without diffraction loss to maximize the coverage range.

12. A non-transitory computer-readable medium for generating a cellular footprint of a Radio Access Network (RAN) antenna, the non-transitory computer-readable medium storing instructions that, when executed, cause one or more processors to perform steps of:
obtaining antenna transmission power (Ptx), antenna gain (G(φ,θ)), and cable and connector loss (Lcable) for the RAN antenna;
selecting a target power sensitivity value and a set of horizontal directions (q);
for each direction φ in the set of horizontal directions:
initializing a distance value between the antenna and a user device;
determining a propagation loss (Lprop) for the distance value based on a propagation model;
determining a diffraction loss (Ldiff) for the distance value based on terrain elevation data along a line of sight between the antenna and the user device;
determining an expected received power (Prx) using a link budget expression incorporating Ptx, G(φ,θ), Lcable, Lprop, and Ldiff;
iteratively adjusting the distance value until Prx converges to the target power sensitivity, thereby determining a maximum distance at which the antenna can achieve the target sensitivity in direction q; and
generating the antenna footprint as a function of maximum distance values across all directions φ.

13. The non-transitory computer-readable medium of claim 12, wherein the antenna gain (G(φ,θ)) is calculated based on horizontal and vertical radiation pattern diagrams of the antenna, including consideration of antenna tilt, beamwidth, and front-back ratio.

14. The non-transitory computer-readable medium of claim 12, wherein the propagation loss (Lprop) is calculated using a line-of-sight model, the model being chosen based on a deployment environment including any of Rural Macro (RMa), Urban Macro (UMa), and Urban Micro (UMi) scenarios.

15. The non-transitory computer-readable medium of claim 12, wherein the diffraction loss (Ldiff) is calculated based on a number of topographic obstructions intersecting the line of sight.

16. The non-transitory computer-readable medium of claim 12, wherein the steps further include post-processing data such that a maximum distance at which a higher sensitivity is achieved is not less than a distance for a lower sensitivity in a same direction.

17. The non-transitory computer-readable medium of claim 12, wherein the steps further include interpolating distance values for directions in which the method fails to converge, based on corresponding distance values from adjacent directions.

18. The non-transitory computer-readable medium of claim 12, wherein the distance value is calculated by estimating a distance at which the target sensitivity is met without accounting for diffraction loss (Ldiff).

19. The non-transitory computer-readable medium of claim 12, wherein the method is repeated for a plurality of target power sensitivity values, resulting in a plurality of footprint contours corresponding to different receiver sensitivity thresholds.

20. The non-transitory computer-readable medium of claim 12, wherein terrain elevation data is derived from a topographical database, including Shuttle Radar Topography Mission (SRTM) data.
